(19) United States
(12) Patent Application Publication
(10) Pub. No.: US 2012/0030760 A1
(43) Pub. Date: Feb. 2, 2012

(54) METHOD AND APPARATUS FOR COMBATING WEB-BASED SURREPTITIOUS BINARY INSTALLATIONS

(76) Inventors: Long Lu, Atlanta, GA (US); Phillip Porras, Cupertino, CA (US); Vinod Yegneswaran, Foster City, CA (US)

(21) Appl. No.: 12/848,827

(22) Filed: Aug. 2, 2010

(51) Int. Cl. G06F 21/00

(52) U.S. Cl. 726/23

(57) ABSTRACT

The present invention relates to a method and apparatus for combating web-based surreptitious binary installations. One embodiment of a method combating web-based surreptitious binary installations on a computing device includes intercepting a download of a file to a local file system of the computing device, storing the file in the local file system when the file is correlated with a user consent, and storing the file in a secure zone of the computing device when the file is not correlated with a user consent, wherein files stored in the secure zone cannot be executed or propagated.

### REFERENCE TO GOVERNMENT FUNDING

This application was made with Government support under contract no. W911 NF-06-1-0316 awarded by the Army Research Office and contract no. CNS-0831170 awarded by the National Science Foundation. The Government has certain rights in this invention.

### FIELD OF THE INVENTION

The present invention relates generally to computer security, and relates more particularly to surreptitious installations of malicious code.

### BACKGROUND OF THE DISCLOSURE

Web-based surreptitious binary installations (also known as “drive-by” infections) have become a dominant method through which malicious software propagates through the Internet.

When receiving data content from a web server, a web browser typically handles the received content in one of two basic ways: as supported files types (e.g., hypertext markup language (.html), joint photographic experts group (.jpeg), or the like) or as unsupported file types (e.g., executable file (.exe), compression file (.zip), or the like). Typically, the browser will automatically fetch and render all supported file types. However, the browser must prompt the user for permission to fetch and render unsupported file types.

Although this approach is effective in protecting computing devices from some malicious code, drive-by infections manage to deliver malicious, unsupported content by circumventing the user prompt interactions that are normally required for unsupported content to gain access to a computing device.

### SUMMARY OF THE INVENTION

The present invention relates to a method and apparatus for combating web-based surreptitious binary installations. One embodiment of a method combating web-based surreptitious binary installations on a computing device includes intercepting a download of a file to a local file system of the computing device, storing the file in the local file system when the file is correlated with a user consent, and storing the file in a secure zone of the computing device when the file is not correlated with a user consent, wherein files stored in the secure zone cannot be executed or propagated.

### BRIEF DESCRIPTION OF THE DRAWINGS

The teachings of the present invention can be readily understood by considering the following detailed description in conjunction with the accompanying drawings, in which:

FIG. 1 is a schematic diagram illustrating one embodiment of a system for combating web-based surreptitious binary installations, according to the present invention;

FIG. 2 is a flow diagram illustrating a method for combating web-based surreptitious binary installations, according to the present invention;

FIG. 3 is a flow diagram illustrating a method for inferring consent to a file download, according to the present invention; and

FIG. 4 is a high level block diagram of the present invention implemented using a general purpose computing device.

To facilitate understanding, identical reference numerals have been used, where possible, to designate identical elements that are common to the figures.

### DETAILED DESCRIPTION

The present invention relates to a method and apparatus for combating web-based surreptitious binary installations (also known as “drive-by” infections). Embodiments of the invention intercept and impose “execution prevention” on all content whose download has not been directly authorized through a user-to-browser interaction. This protection does not require prior knowledge of the exploit method, and thus is resistant to circumvention (e.g., by code obfuscation or zero-day threats).

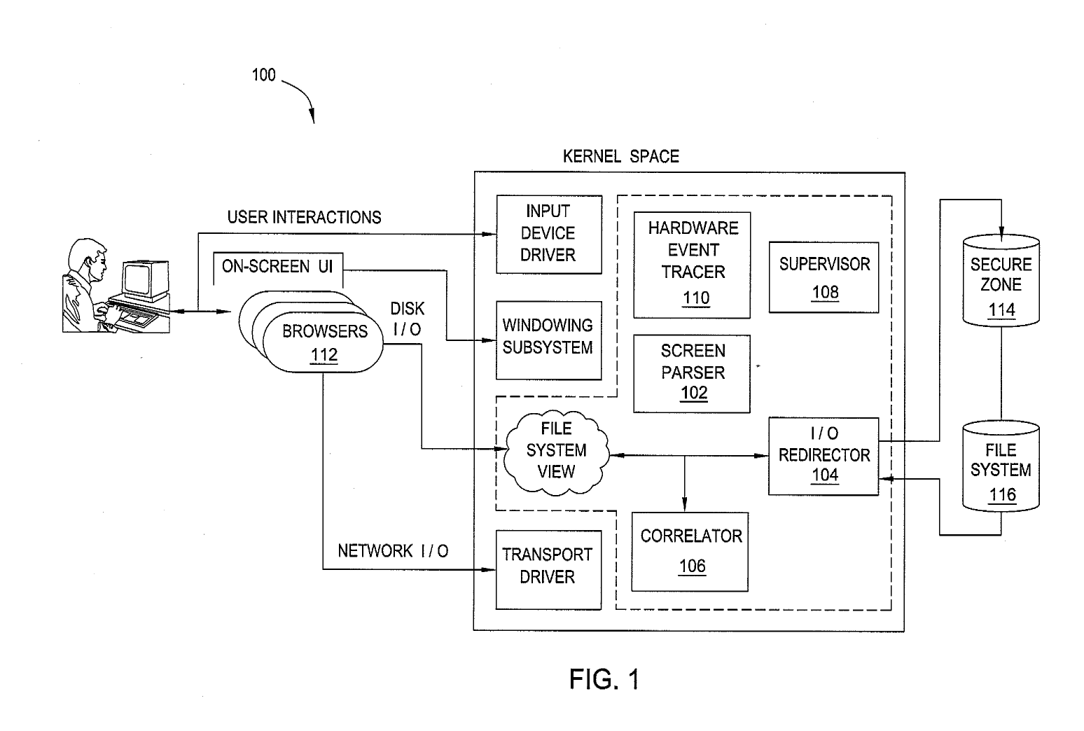

FIG. 1 is a schematic diagram illustrating one embodiment of a system 100 for combating web-based surreptitious binary installations, according to the present invention. The system 100 is implemented within a computing device that is operated by a user. Specifically, all or part of the system 100 is implemented within the kernel of the computing device's operating system (OS) 100. The system 100 comprises five main components: a screen parser 102, an input/output (I/O) redirector 104, a correlator 106, a supervisor 108, and a hardware event tracer 110.

In general, the screen parser 102 and the hardware event tracer 110 make up the front end of the system 100. The front end is responsible for: (1) collecting information displayed on the screen of the computing device; and (2) tracking the computing device's interactions with a user. The I/O redirector 104 and the correlator 106 make up the back end of the system 100. The back end is responsible for: (1) correlating inferred authorizations from the front end with initiated download tasks; and (2) enforcing a non-execution policy for downloads that are not directly authorized by the user. The supervisor 108 coordinates the operations of the front end and the back end in order to detect attempts to install web-based surreptitious binary installations on the computing device.

More specifically, the screen parser 102 monitors the status changes of on-screen user interface elements in real time. For example, the screen parser 102 monitors the on-screen user interface elements for the appearance of download consent dialogs (Le., prompts created by the web browsers 112 or by plug-ins that seek permission from the user to download content). The screen parser 102 uses simple heuristics to identify the user interface elements of interest for each web browser 112, where each heuristic describes a user interface window of interest in terms of a “signature” (i.e., its internal element organization and its associated attributes and values).

In one embodiment, the screen parser 102 registers a plurality of event handlers through the non-blocking event notification mechanism of the Microsoft Active Accessibility (MSAA) technology. In one embodiment, these event handlers handle events that indicate when the currently focused window appearing on the screen of the computing device is changed, moved, or resized.

In one embodiment, the screen parser 102 is implemented in the user space, which allows the screen parser 102 to operate as a non-blocking monitoring mechanism (whereas a kernel-level implementation would necessitate a blocking implementation). In one embodiment, the screen parser 102 operates continuously (i.e., it never stops monitoring). The screen parser 102 reports to the supervisor 108 when a download consent dialog appears. This report includes any information parsed from the dialog(s).

The hardware event tracer 110 intercepts user input events (e.g., inputs received via a mouse, a keyboard, or other modalities) that may indicate the user's response to a download consent dialog. Thus, the hardware event tracer 110 tracks user interaction with the user interface at the hardware level. For example, the hardware event tracer 110 takes as input the on-screen coordinates of confirmation user interface elements and user input combinations that correspond to user authorization for content downloads. The hardware event tracer reports these user input events to the supervisor 108.

In one embodiment, the hardware event tracer 110 does not begin tracking an interaction until it is commanded to do so by the supervisor 108. Similarly, although the hardware event tracer 110 typically terminates tracking upon capturing a response from the user, the hardware event tracer 110 may also terminate tracking upon command from the supervisor 108.

In one embodiment, the hardware event tracer 110 is implemented as a filter driver that is inserted into the driver stack through which every hardware event must pass before reaching the upper level kernel subsystems. In a further embodiment, the hardware events of input devices are obtained by the windowing subsystem by actively polling the device driver using I/O request packets (IRPs). By installing a callback that intercepts the downward IRP request, the hardware event tracer 110 ensures that it is notified when the completed IRP goes up and event information can be extracted.

The supervisor 108 is a system component (e.g., as opposed to a human supervisor) that coordinates the operations of the other system components. For instance, the supervisor 108 assigns tasks to other kernel components and coordinates their execution (e.g., such as for responding to notifications received from the screen parser 102). The supervisor 108 also manages the internal communications among the system components, including user-kernel communication backed by device input and output controls (IOCTLs) and kernel-kernel communication implemented by sharing a non-paged pool across all kernel components as a means of information exchange (e.g., spin-lock based synchronizations may be used to protect the integrity of shared data).

The supervisor 108 also maintains a list of all supervised processes on the computing device. Certain routines of the system 100 (e.g., screen parsing and stream recording) only need to be applied to supervised processes, while not affecting other processes or imposing unnecessary performance overhead. However, other routines of the system 100 (e.g., input/output redirection, discussed in greater detail below) need to intercept all file operations of supervised processes, but none of the file operations of other processes. In one embodiment, the list of supervised processes is initialized with only the browser process, but other supervised processes are added to the list as they are created by processes already on the list. When a supervised process is terminated, it is removed from the list.

Additionally, the supervisor 108 tracks remote thread creations. For instance, the supervisor 108 may record threads created by supervised processes when the parent processes are not supervised. These remote threads and their parents processes are included in the list of supervised processes.

The supervisor 108 receives inputs from the screen parser 102 and the hardware event tracer 110, as discussed above. In one embodiment, the supervisor 108 independently validates the authenticity of each download consent event reported by the screen parser 102. In a further embodiment, the supervisor 108 does not recognize a download authorization until user consent is captured and reported by the hardware event tracer 110.

The supervisor 108 also sends commands to the correlator 106 to commence a stream recording process, as discussed in greater detail below.

The correlator 106 correlates user download authorizations (inferred by the front end) with downloaded content. Since the system 100 is independent of the web browsers 112 and treats them as black boxes, only the external behavior of the web browsers 112 (i.e., the interactions with the operating system) are visible to the system 100. Hence, the correlator 106 analyzes information available in the OS kernel rather than focus on the internal download handling of the web browsers 112. As the web browsers 112 invariably rely on the OS to provide network and file system capabilities, all kernel drivers includes the correlator 106 have the opportunity to observe each transaction and to retrieve information about each process. For example, network traffic incurred by a web browser 112 is fully transparent to the correlator 106 (at multiple kernel system levels) while the traffic is being processed in the OS network protocol stack. Similarly, the correlator 106 can intercept activity related to file system writes by the web browsers 112.

In one embodiment, the correlator 106 associates an instance of downloaded content with a user authorization in two steps. First, the correlator 106 discovers a candidate file (i.e., instance of downloaded content). Second, the correlator 106 validates the authenticity of the candidate file. A file that satisfies these two steps while being correlated with a user download authorization is assumed to comply with the user download authorization.

The I/O redirector 104 quarantines downloaded content that cannot be correlated with a user download authorization. In particular, the I/O redirector redirects this downloaded content to a secure zone 114 within the computing device (rather than to the computing device's file system 116). As discussed in greater detail below, the secure zone 114 is a special region of the local file system. Content stored in the secure zone 114 cannot be executed or propagated.

The I/O redirector 104 is capable of intercepting each file access request before it reaches the file system driver. The I/O redirector 104 is also capable of modifying these requests accordingly to ensure that all of the file write operations carried out by supervised processes are redirected to the secure zone 114, while also maintaining the consistency of read operations.

In one embodiment, the I/O redirector 104 enforces the following policies: (1) any file being created by a supervised process will be saved in the secure zone 114 directly; (2) any file being modified by a supervised process will be saved as a shadow copy in the secure zone 114, without change to the original file; (3) files in the secure zone 114 are organized in the same hierarchy as they would have been without redirection, except for the root being the secure zone 114; (4) only supervised processes can access files in the secure zone 114 via the I/O redirector 104; and (5) no execution is allowed for files stored within the secure zone 114.

In one embodiment, the first three of these policies are enforced by the I/O redirector 104 as follows. Upon receiving a request from a web browser 112 to write a file to the disk (i.e., to open a file handle with write privilege), the I/O redirector 104 first verifies the existence of the file's shadow copy. If the shadow copy exists (i.e., the file has been previously created or modified by a supervised process), then the I/O redirector 104 immediately forwards the request to the file system driver with the target being modified into the path of the shadow copy. However, if the shadow copy does not exist, the I/O redirector 104 may need to create a shadow copy before modifying and redirecting the request (depending on whether the request is to create a new file or to modify or replace an old file). Finally, the web browser 112 obtains the returned file handle and is unaware that it is operating on a shadow copy of the file in the secure zone 114.

In the case of a read request, the request is redirected to the shadow copy. If a shadow copy does not exist, then the request is passed to the file system 116 without the need for redirection. The I/O redirector 104 also provides a different file system view to supervised processes, which hides the separation of files inside and outside the secure zone 114.

In one embodiment, the fourth policy is enforced by the I/O redirector 104 as follows. The I/O redirector 104 simply passes through file access requests from processes that are not supervised (i.e., no redirection occurs), except for those requests that are obtaining handles to files in the secure zone 114. This ensures that files in the secure zone 114 are not propagated.

In one embodiment, the fifth policy is enforced by the I/O redirector 104 by blocking executable images from being mapped into the memory. Specifically, the I/O redirector 104 filters out file opens that lead to executions by checking certain parameters associated with the open request and disallowing these file opens so that the execution attempts will fail due to the lack of read permissions. This approach prevents file executions and is able to reliably select all types of execution requests that are serviced by the OS, including normal program start-ups (e.g., .exe, .msi), dynamic library (e.g., .dll) loads, and driver module (e.g., .sys) installations.

In one embodiment, the I/O redirector 104 is implemented as a File System Minifilter Driver. Minifilters can register callbacks on interested types of file system requests, which provide opportunities to observe or change various kinds of information associated with those types of requests. By registering a pre-operation callback for three types of requests, discussed in further detail below, the I/O redirector 104 can capture all file open operations and reliably detect file executions before the request is delivered to the file system driver.

Two types of requests for which a pre-operation callback can be registered are IRP_MJ_CREATE and IRP_MJ_NETWORK_QUERY_OPEN. These types of requests are respectively generated by two different file I/O mechanisms that the WINDOWS operating system provides: IRP-based and fast-IO-based file drivers. The fast-IO-based approach takes advantage of the in-memory file cache without accessing the file system driver. The coverage of open operations would not be complete if either type of request is not registered. In one embodiment, every file open request preprocessed by the I/O manager of the OS results in the invocation of a callback and an initiation of the redirection technique described in further detail below.

Another type of request for which a pre-operation callback can be registered is IRP-MJ_ACQUIRE_FOR_SECTION_SYNCHRONIZATION. The I/O redirector 104 needs to reliably verify whether a secure zone file access represents an execution attempt. However, solely relying on checking execution flags associated with a file open request could trigger false positives. For example, the FILE_EXECUTE flag being set in CreateOptions when calling ZwCreateFiles does not necessarily mean the file will be executed. To address this, embodiments of the invention explicitly verify whether the page permission of a section being synchronized or created is PAGE_EXECUTE. This helps identify file executions (e.g., creating a process, loading a dynamic library or a driver, etc.). In one embodiment, a section with PAGE_EXECUTE permission is exclusively created when loading executable images, and all system-defined process loads perform this operation.

After each file open request originated from the user level is preprocessed by the I/O manager, the I/O redirector 104 invokes a redirection callback routine with the input of the preprocessed request. In one embodiment, the callback routine checks an incoming I/O request in order to verify whether the requester is a supervised process or the whether the subject file resides in the secure zone 114. If both conditions are false, the I/O request is forwarded to the file system driver. Thus, the check helps to filter out most file I/O operations that are not relevant to the system 100. If the requester is a supervised process, a second check is performed to pass through and reparse the I/O request that was generated by a previous redirection (because the necessary checks and processing were already performed during the previous redirection). These first two checks are considered “light weight” because they do not require additional context beyond the I/O request and because they can finish within a relatively constant time. The I/O requests that remain after the light weight checks are the ones that need to be redirected and require special handling.

The concept of reparsing, discussed above, refers to an operation in which open requests on files with reparse tags are forwarded by the file system 116 to an appropriate file system filter. In one embodiment, this capability is provided using minifilters and enables I/O redirection through the modification of attributes within a file access operation (such as the destination path). This allows the I/O manager to reparse the file.

In one embodiment, the I/O redirector 104 modifies the I/O request to be redirected with the path of the shadow copy and then sends the I/O request back to the I/O manager to be reparsed. Thus, the second check discussed above ensures that the reparsed request does not go through the I/O redirector again and trigger the callback.

The I/O redirector 104 employs several other techniques to aid in redirection including rebuilding the hierarchy of directories, special handling of move/rename operations, and Fast_IO.

Each time the I/O redirector 104 decides to redirect an open I/O request, the I/O redirector 104 must ensure that the parent path of the redirected I/O request exists in the secure zone 114 prior to having the I/O manager reparse the open I/O request. The directory hierarchy has to be rebuilt in the secure zone 114 if it has not already been rebuilt.

In addition, some operating systems use a specially formed open request during a sequence of operations while moving or renaming a file, which needs special handling during redirection. This request, identified by a special bit (e.g., SL_OPEN_TARGET-DIRECTORY in the WINDOWS operating system), requires a different way to parse the path of its target, from which a current redirection path can be composed. Move/rename operations are commonly used by web browsers to convert temporary files to normal files when a download finishes.

Finally, when the I/O redirector 104 finds that an I/O request to be reparsed is the result of a Fast_IO, the I/O redirector 104 denies the I/O request by instructing the I/O manager to reissue an IRP-based request. Fast_IO is not allowed in this scenario because Fast IO uses the file cache without accessing the file system and therefore cannot be reparsed or redirected.

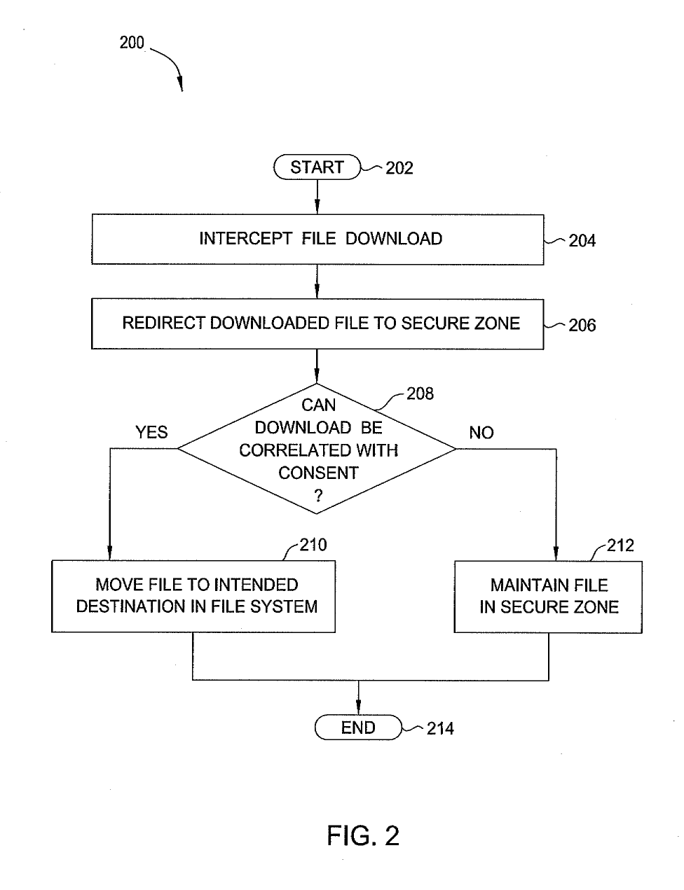

The secure zone 114, discussed above, is a special region of the local file system 116 that contains files that have been written by supervised processes. The purpose of the secure zone 114 is to ensure that the files contained therein can neither be executed nor propagated. Use of the secure zone 114 is discussed in greater detail with respect to FIG. 2, which illustrates a process by which the system 100 monitors and analyzes downloaded content.

FIG. 2 is a flow diagram illustrating a method 200 for combating web-based surreptitious binary installations, according to the present invention. The method 200 may be implemented, for example, by the system 100 illustrated in FIG. 1. In particular, the method 200 may be implemented by the back end of the system 100. As such, reference is made in the discussion of FIG. 2 to various elements of FIG. 1. It will be appreciated, however, that the method 200 is not limited to execution within a system configured exactly as illustrated in FIG. 1 and, may, in fact, execute within systems having alternative configurations.

The method 200 is initialized in step 202 and proceeds to step 204, where the I/O redirector 104 intercepts a file download. The file download is a disk write operation initiated by a supervised process of the web browser 112.

In step 206, the I/O redirector 104 redirects the downloaded file to the secure zone 114. As discussed above, the I/O redirector 104 accomplishes this redirection by modifying the disk write operation in accordance with a shadow copy of the downloaded file.

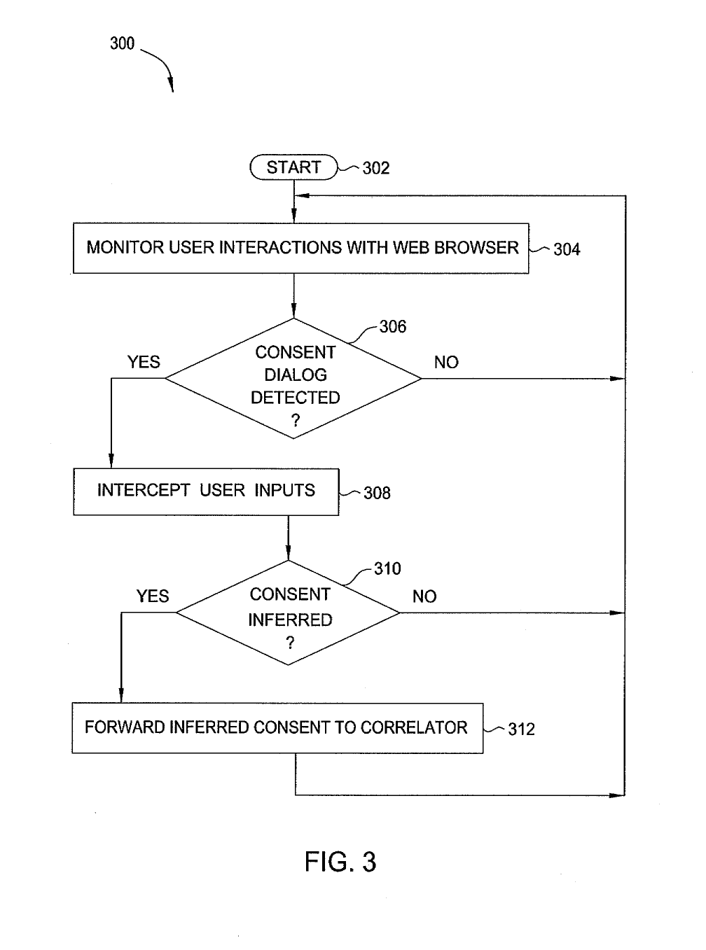

In step 208, the correlator 208 determines whether the file download can be correlated with an inferred consent. One embodiment of a method for inferring consent to a file download is discussed in greater detail with respect to FIG. 3.

If the correlator 106 concludes in step 208 that the file download can be correlated with an inferred consent, then the I/O redirector 104 move the downloaded file to the intended destination in the file system 116 in step 210. In one embodiment, this move is accomplished by modifying the file system metadata (e.g., as opposed to copying the downloaded file), which can be finished in constant time.

Alternatively, if the correlator concludes in step 208 that the file download cannot be correlated with an inferred consent, then the downloaded file is maintained in the secure zone in step 212. As discussed above, files in the secure zone cannot be executed or propagated. Once the downloaded file has been disposed of appropriately in accordance with either step 210 or 212, the method 200 terminates.

FIG. 3 is a flow diagram illustrating a method 300 for inferring consent to a file download, according to the present invention. The method 300 may be implemented, for example, by the system 100 illustrated in FIG. 1. In particular, the method 300 may be implemented by the front end of the system 100. As such, reference is made in the discussion of FIG. 3 to various elements of FIG. 1. It will be appreciated, however, that the method 300 is not limited to execution within a system configured exactly as illustrated in FIG. 1 and, may, in fact, execute within systems having alternative configurations.

The method 300 is initialized in step 302 and proceeds to step 304, where the screen parser 102 monitors a user's interactions with the web browsers 112. In particular, the screen parser 102 monitors the status changes of the on-screen user interface elements in real time. As discussed above, the screen parser 102 performs this operation continuously.

In step 306, the screen parser 102 determines whether a download consent dialog has been detected on the screen of the user's computing device. As discussed above, a download consent dialog is an on-screen dialog or prompt that is created by a web browser or plug-in and presented to the user in order to solicit the user's consent to download a file (typically of an unsupported type such as .exe or .zip) onto the computing device. In one embodiment, the screen parser 102 employs a set of signatures that define the external appearance and internal hierarchy of known classes of download consent dialogs (the download consent dialogs used by most web browsers are relatively well-defined). These signatures help the screen parser 102 to identify when a download consent dialog is displayed on the screen of the computing device.

If the screen parser 102 concludes in step 306 that a download consent dialog has not been detected, then the method 300 returns to step 304, and the screen parser continues to monitor the user's interactions with the web browser.

Alternatively, if the screen parser 102 concludes in step 306 that a download consent dialog has not been detected, then the hardware event tracer 110 begins to intercept user inputs (e.g., mouse or keyboard inputs) occurring subsequent to the download consent dialog in step 308. The intercepted user inputs are input events that are considered to trigger a download consent (e.g., hitting the “Enter” key on the keyboard or clicking an “OK” button in the user interface with the mouse).

In one embodiment, interception of user inputs is facilitated by an instruction from the supervisor 108, to whom the screen parser reports the detected download consent dialog (along with other information parsed from the download consent dialog, such as uniform resource locator, file name, or the like). In one embodiment, the hardware event tracer 110 is notified of the on-screen coordinates of the download consent dialog and of the particular user input events that correspond to user consent for the particular download consent dialog being displayed. Thus helps the hardware event tracer 110 to identify which user input events may be relevant to the detected download consent dialog.

In step 310, the supervisor 108 determines whether consent to the requested download can be inferred. This inference is based on knowledge of the location and characteristics of the detected download consent dialog (as reported by the screen parser 102), as well as on knowledge of the subsequent user inputs (as reported by the hardware event tracer 110). For example, a mouse click received in a region of the user interface where the “OK” button of the download consent dialog is expected to be displayed may indicate that the user consented to the download.

If the supervisor 108 concludes in step 310 that consent cannot be inferred, then the method 300 returns to step 304, and the front end of the system 100 continues to monitor the user interactions and input events.

Alternatively, if the supervisor 108 concludes in step 310 that consent can be inferred, then the supervisor 108 forward the inferred consent to the correlator 106 in step 312. In one embodiment, the inferred consent is forwarded as a two-tuple of the remote uniform resource locator and the local storage path for the associated file (e.g., (URL, Path)). This tuple identifies the remote file that is expected and its local storage location, which can uniquely define download consent. As discussed above, the correlator 106 correlates this inferred consent with a file that has actually been downloaded. The method 300 then returns to step 304 and continued to monitor the user's interactions with the web browser.

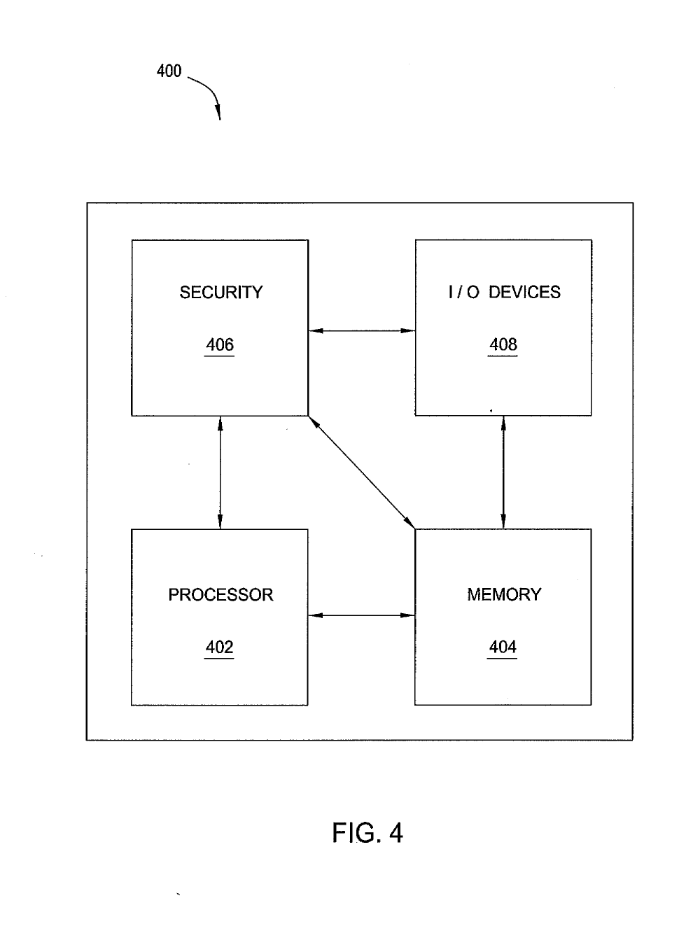

FIG. 4 is a high level block diagram of the present invention implemented using a general purpose computing device 400. It should be understood that embodiments of the invention can be implemented as a physical device or subsystem that is coupled to a processor through a communication channel. Therefore, in one embodiment, a general purpose computing device 400 comprises a processor 402, a memory 404, a security module 405, and various input/output (I/O) devices 406 such as a display, a keyboard, a mouse, a modem, a microphone, speakers, a touch screen, and the like. In one embodiment, at least one I/O device is a storage device (e.g., a disk drive, an optical disk drive, a floppy disk drive).

Alternatively, embodiments of the present invention (e.g., security module 405) can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the security module 405 for combating web-based surreptitious binary installations described herein with reference to the preceding Figures can be stored on a non-transitory computer readable medium (e.g., RAM, magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Although various embodiments which incorporate the teachings of the present invention have been shown and described in detail herein, those skilled in the art can readily devise many other varied embodiments that still incorporate these teachings.

What is claimed is:

1. A method for combating web-based surreptitious binary installations on a computing device, the method comprising:
intercepting a download of a file to a local file system of the computing device;
storing the file in the local file system when the file is correlated with a user consent; and
storing the file in a secure zone of the computing device when the file is not correlated with a user consent, wherein files stored in the secure zone cannot be executed or propagated.

2. The method of claim 1, wherein the intercepting further comprises:
automatically redirecting the file to the secure zone at least temporarily; and
attempting to correlate the file to a user consent prior to storing the file.

3. The method of claim 1, wherein the user consent is inferred.

4. The method of claim 3, wherein the user consent is inferred by:
monitoring one or more user interactions with a web browser for the appearance of a download consent dialog;
intercepting one or more user inputs to the computing device subsequent to the appearance of the download consent dialog; and
inferring the user consent when the one or more user inputs indicate an authorization of the download consent dialog.

5. The method of claim 4, wherein the monitoring comprises:
maintaining one or more signatures, where each of the one or more signatures identifies an external appearance and an internal hierarchy of a class of download consent dialogs;
comparing one or more user interface elements displayed on a screen of the computing device to the one or more signatures; and
detecting the download consent dialog when the one or more user interface elements matches one of the one or more signatures.

6. The method of claim 4, wherein the one or more user inputs are received via at least one of: a keyboard or a mouse.

7. The method of claim 1, wherein the download is initiated by a supervised process of a web browser.

8. The method of claim 1, wherein the method is implemented within a kernel of an operating system of the computing device.

9. A non-transitory computer readable medium containing an executable program for combating web-based surreptitious binary installations on a computing device, where the program performs steps comprising:
intercepting a download of a file to a local file system of the computing device;
storing the file in the local file system when the file is correlated with a user consent; and
storing the file in a secure zone of the computing device when the file is not correlated with a user consent, wherein files stored in the secure zone cannot be executed or propagated.

10. The non-transitory computer readable medium of claim 9, wherein the intercepting further comprises:
automatically redirecting the file to the secure zone at least temporarily; and
attempting to correlate the file to a user consent prior to storing the file.

11. The non-transitory computer readable medium of claim 9, wherein the user consent is inferred.

12. The non-transitory computer readable medium of claim 11, wherein the user consent is inferred by:
monitoring one or more user interactions with a web browser for the appearance of a download consent dialog;
intercepting one or more user inputs to the computing device subsequent to the appearance of the download consent dialog; and
inferring the user consent when the one or more user inputs indicate an authorization of the download consent dialog.

13. The non-transitory computer readable medium of claim 12, wherein the monitoring comprises:
maintaining one or more signatures, where each of the one or more signatures identifies an external appearance and an internal hierarchy of a class of download consent dialogs;
comparing one or more user interface elements displayed on a screen of the computing device to the one or more signatures; and
detecting the download consent dialog when the one or more user interface elements matches one of the one or more signatures.

14. The non-transitory computer readable medium of claim 12, wherein the one or more user inputs are received via at least one of: a keyboard or a mouse.

15. The non-transitory computer readable medium of claim 9, wherein the download is initiated by a supervised process of a web browser.

16. The non-transitory computer readable medium of claim 9, wherein the method is implemented within a kernel of an operating system of the computing device.

17. A system for combating web-based surreptitious binary installations on a computing device, the system comprising:
an I/O redirector for intercepting a download of a file to a local file system of the computing device;
a correlator for correlating the file to a user consent;
a local file system for storing the file when the file is correlated with a user consent; and
a secure zone for storing the file when the file is not correlated with a user consent, wherein the secure zone prevents the file from executing or propagating.

18. The system of claim 17, further comprising:
a screen parser for monitoring one or more user interactions with a web browser for the appearance of a download consent dialog;
a hardware event tracer for intercepting one or more user inputs to the computing device subsequent to the appearance of the download consent dialog; and
a supervisor inferring the user consent when the one or more user inputs indicate an authorization of the download consent dialog.

19. The system of claim 18, wherein the supervisor further coordinates one or more operations of the I/O redirector, the correlator, the screen parser, and the hardware event tracer.

20. The system of claim 17, wherein the system is implemented within a kernel of an operating system of the computing device.
